(19) United States
(12) Patent Application Publication
(10) Pub. No.: US 2023/0159798 A1
(43) Pub. Date: May 25, 2023

(54) FLEXIBLE AND LOW PERMEABLE VAPOR RETARDANTS FOR FACING PRODUCTS

(71) Applicant: JOHNS MANVILLE, Denver, CO (US)

(72) Inventors: Joshua Merrell Boyce, Littleton, CO (US); Anthony Edward Moore, Glen Allen, VA (US)

(21) Appl. No.: 17/530,816

(22) Filed: Nov. 19, 2021

(51) Int. Cl. C09J 121/02; C09J 5/00; B32B 5/02; B32B 29/02; B32B 15/14; B32B 27/32; B32B 27/36; B32B 7/12; B32B 27/12

(52) U.S. Cl. CPC C09J 121/02; C09J 5/00; B32B 5/028; B32B 29/02; B32B 15/14; B32B 27/32; B32B 27/36; B32B 7/12; B32B 27/12; C09J 2400/166; C09J 2400/286; C09J 2421/00; B32B 2262/101; B32B 2307/3065; B32B 2307/732; B32B 2260/048; B32B 2260/021; B32B 2305/08

(57) ABSTRACT

Described herein are non-halogenated flame resistant adhesive compositions, halogen-free vapor retarders, facings for insulation products, and more specifically to flexible, low permeance facings utilizing non halogenated flame retardant systems for insulation products, and processes for making such products. The non-halogenated flame resistant adhesives can comprise non-halogenated latexes and/or non-halogenated flame retardants. The insulation products described herein may include a base insulation layer composed of or including a composite or construction board, blanket, batt, pipes, or roll. An insulation product as provided includes a base insulation layer (e.g., a construction or composite board) and at least one halogen-free facer bonded with a non-halogenated flame resistant adhesive composition to one or more sides or surfaces of the base insulation layer.

### BACKGROUND

The present disclosure relates generally to non-halogenated flame retardant adhesive systems; flexible, low permeance vapor retarders; facings for insulation products; and more specifically to flexible, low permeance facings utilizing non halogenated flame retardant adhesive systems for insulation products.

Vapor retarders or vapor barriers are useful in any number of products, for example facings for insulation products. Facings (also referred to as facers) relate to the external, protective surface-facing or jacketing positioned on one or more sides on insulations used for pipes or HVAC ductwork, for example. Facings and jacketings may serve several purposes in air handling and piping applications, helping systems to meet building codes and achieve better energy efficiency through condensation control, enhanced fire performance, and providing protective surface barriers.

Foil-scrim-kraft (“FSK”) is a flexible, low permeance, vapor-barrier. During the manufacturing process of an FSK facing, a layer of lightweight aluminum foil is layered against a multi-directional, reinforcing fiberglass scrim (yarn) and paired with a final layer of kraft brown paper, laminated together using a flame-retardant adhesive. Current products use flame retardant materials that contain varying percentages of halogens such as chlorine, and bromine.

Once the lamination process is complete, the facing is wound onto rolls for use on manufacturing and fabrication lines. Fiberglass insulation may be adhered to the foil surface, or more commonly, the kraft paper side of the facing, Faced fiberglass may be fabricated into a range of products including but not limited to duct wrap, duct boards, or mechanical boards. The FSK facing not only serves as a vapor-barrier to facilitate condensation control, but also a flame resistant protective barrier for the fiberglass insulation. The aluminum foil gives FSK its distinctive silver color. Foil tape that matches the FSK facing aesthetic may be used to seal joints and seams or to join insulation pieces together, providing a uniform appearance on FSK-faced products used in traditional insulated ductwork applications.

Another facing found in the insulation industry is the All Service Jacket (“ASJ”). ASJ is also a flare-retardant vapor-barrier facing. It is manufactured similarly to the FSK facing, using lightweight aluminum foil layered with a multi-directional fiberglass reinforcing scrim, and a bleached white kraft paper. As with FSK facing, these layers are laminated together using a flame-retardant adhesive. As with FSK facing, current products use flame retardant adhesive materials that contain varying percentages of halogens.

ASJ facing is commonly used as a jacketing for rigid fiberglass pipe insulation. ASJ jacketing is also produced in rolls, which are then adhered to fiberglass pipe coverings with adhesive. A key difference between FSK and ASJ is that the bleached white kraft paper of ASJ is typically installed facing outward, giving the insulated pipe a clean, aesthetically pleasing, white facing.

The traditional white look of ASJ has been an industry standard for pipe insulation jacketing for decades. The white appearance is often preferred for aesthetic purposes, as the ASJ jacketing is typically used on exposed piping systems within a building making ASJ facing a great choice for a clean, crisp appearance for occupants. ASJ also provides pipe insulation with several necessary features for performance, such as a vapor-barrier, a fire-resistant barrier, and insulation protection.

However, the use and manufacture of halogenated materials can include risks of toxicity. In addition, halogenated materials may be disfavored by consumers and/or regulatory agencies. The need remains for vapor retarders or facings that are flexible, with low permeance, and are halogen-free.

### BRIEF SUMMARY

The embodiments described herein relate generally to halogen-free lamination adhesive compositions which, for example, can be used in vapor retarder/barrier products such as facers for insulation products, and more specifically can relate to halogen-free facers for fiberglass based construction products. The insulation products may include a base insulation layer constructed or composed of an insulation product, (e.g., a construction board, a blanket, a batt, a pipe, a roll, or combinations thereof). The insulation product can, in some embodiments, include at least a fiberglass based layer made of an inorganic material (e.g., glass fibers) and a halogen-free facer on one or more sides or surfaces of the fiberglass based layer.

The halogen-free facer can be composed of or include one or more layers. For example, the halogen-free facer may include first and second face material (e.g., paper, film, and/or foil) layers and a reinforcing layer sandwiched therebetween, and bonded together with a halogen-free adhesive composition. In some embodiments, the halogen-free adhesive composition can comprise a non-halogenated flame retardant and a non-halogenated latex.

In some embodiments, the halogen-free facer includes two or more layers configured to be coupled to an insulation layer to form an insulation product. The two or more layers can exclude a moisture absorbing layer between the two or more layers in some embodiments. In some embodiments, the two or more layers include a first face material or film layer and a second face material or film layer. The first and second film layers can sandwich a reinforcing layer therebetween. In some embodiments, the halogen free-facer can be adhered to a base insulation layer to form an insulation product. The base insulation layer may include a fiberglass based insulation product. The halogen-free facer may have a thickness in a range between 0.002 and 0.01 inches (e.g., between 0.003 and 0.009 inches, between 0.004 and 0.008 inches, between 0.004 and 0.006 inches), for example.

Thus, some aspects of the disclosure can involve a halogen-free lamination adhesive composition, comprising a non-halogenated flame retardant and a non-halogenated latex, where the lamination adhesive composition is configured for use in a FSK or ASJ product. In some embodiments, the non-halogenated latex and/or the non-halogenated flame retardant comprises at least one phosphate-containing compound. When both the non-halogenated latex and the non-halogenated flame retardant comprise at least one phosphate-containing compound, at least one phosphate-containing compound can be the same or different.

Some embodiments relate to a vapor retarder material, comprising a first face material, a second face material, a non-halogenated flame retardant, and a non-halogenated latex; where the non-halogenated flame retardant and the non-halogenated latex are both located between the first face material and the second face material. In some embodiments, the vapor retarder material can be halogen-free. In some embodiments, the non-halogenated latex and/or the non-halogenated flame retardant comprises at least one phosphate-containing compound. When both the non-halogenated latex and the non-halogenated flame retardant comprise at least one phosphate-containing compound (e.g., a phosphate-containing latex), the at least one phosphate-containing compound can be the same or different. In some embodiments, the first face material and the second face material can each separately be paper, aluminum foil, polymeric film, or combinations thereof. In some embodiments, a reinforcing material can be positioned between the first face material and the second face material. In some embodiments, the reinforcing material can be a reinforcing scrim (e.g., a bi-directional, a tri-directional scrim, or a multi-directional scrim), for example a scrim made of fiberglass strands.

In some embodiments, the vapor retarder material further comprises a biocide, an inert gas generator, a dispersant, a smoke suppressant, and/or at least one additional flame retardant, and any and all combinations thereof.

In some embodiments, the disclosure relates to a process for making a facing product, such as a FSK or ASJ product, for example, comprising coating an inner surface of a first face material with a non-halogenated adhesive composition, coating an inner surface of a second face material with said non-halogenated adhesive composition, positioning a reinforcing scrim between the coated inner surface of the first face material and the coated inner surface of the second face material, combining the coated inner surface of the first face material with the coated inner surface of the second face material with the reinforcing scrim in between to form a combined layer structure, curing the non-halogenated adhesive composition, and winding the combined layer structure to form a finished roll of FSK or ASJ product. In some aspects, the first face material can comprise paper, such as un-bleached kraft for FSK products or bleached kraft for ASJ products. In some aspects, the second face material comprises a foil, such as an aluminum foil. In some embodiments, the non-halogenated adhesive composition comprises a non-halogenated flame retardant and a non-halogenated latex. In some embodiments, the non-halogenated latex and/or the non-halogenated flame retardant comprises at least one phosphate-containing compound. When both the non-halogenated latex and the non-halogenated flame retardant comprise at least one phosphate-containing compound (e.g., a phosphate-containing latex), the at least one phosphate-containing compound can be the same or different.

In some embodiments, the method of manufacturing a halogen-free facer further includes laminating the halogen-free facer to insulation products. The halogen-free facer may be laminated with between 0.5 g/ft² and 9 g/ft² (e.g., 2 g/ft² and 8 g/ft², 3 g/ft² and 7 g/ft², or 1 g/ft² and 5 g/ft²) weight adhesive), for example, to the insulation product. Preferably, this second adhesive is also non-halogenated. In certain embodiments, the second film layer is laminated directly to a surface of the insulation product with an adhesive without any intermediary layer.

### BRIEF DESCRIPTION OF THE DRAWINGS

FIG. 1 is a sectional view of an insulation product with a base insulation layer and halogen-free facer in accordance with an exemplary embodiment of the present disclosure.

FIGS. 2 and 3 are perspective views of the halogen-free facer and base insulation layers, respectively, of the insulation product of FIG. 1A.

FIG. 4 is an example of a process associated with the production of halogen-free facers as described herein.

### DETAILED DESCRIPTION

The ensuing description provides exemplary embodiments only, and is not intended to limit the scope, applicability or configuration of the disclosure. Rather, the ensuing description of the exemplary embodiments will provide those skilled in the art with an enabling description for implementing one or more exemplary embodiments. It being understood that various changes may be made in the function and arrangement of elements without departing from the spirit and scope of the invention as set forth in the appended claims.

As mentioned, traditionally adhesive systems achieve flame retardancy (FR) through the use of halogenated materials, such as chlorine (Cl) and bromine (Br). For example, a chlorinated latex is often used as an adhesive component. In the event of a fire, Cl and Br are released causing an endothermic reaction and a reduction in the supply of flammable gases. Such systems can include synergistic materials such as aluminum trihydrate (ATH) or magnesium hydroxide (MDH) to boost FR performance as these materials may be more difficult to incorporate in large quantities but can provide FR through different mechanisms. However, the release of halogen gases can potentially be toxic in high concentrations. Due to the adverse health effects of halogens, a non-halogenated adhesive (e.g., one that does not contain halogen or a halogen substituent) composition with similar or better FR properties is desirable.

Non-halogenated flame resistant lamination adhesive compositions are described herein. The non-halogenated adhesive compositions are halogen-free. That is they contain only trace amounts or less than trace amounts of halogens, for example, as measured by Mass Spectrometry, Inductively Coupled Plasma Optical Emission Spectrometry, or other detection methods. In some embodiments, the non-halogenated flame resistant lamination adhesive compositions comprise a non-halogenated latex and a non-halogenated flame retardant. In some embodiments, the non-halogenated latex comprises at least one phosphate-containing compound, such as a phosphate-containing latex. In some embodiments, the non-halogenated flame retardant comprises at least one phosphate-containing compound. When both the non-halogenated latex and the non-halogenated flame retardant comprise at least one phosphate-containing compound (e.g., a phosphate-containing latex), the at least one phosphate-containing compound can be the same or different. In some embodiments, the lamination adhesive composition further comprises a biocide, an inert gas generator, a dispersant, a smoke suppressant (e.g., aluminum trihydrate and/or a zinc phosphate/zinc oxide complex) and/or at least one additional flame retardant, and any and all combinations thereof.

Such non-halogenated flame resistant lamination adhesive compositions can be used in vapor retarder and/or vapor barrier materials, such as facings for insulation. Additional details are provided about the non-halogenated flame resistant lamination adhesive compositions and how they are made, vapor retardants, facings, and fiberglass-containing products made with the adhesive compositions, systems for making those adhesive-containing products, and methods of making those adhesive-containing products, among other features.

Some embodiments described herein are related to facers for insulation products, and more specifically relate to halogen-free facers for fiberglass insulation products. As described herein, the halogen-free facers can include a non-halogenated flame resistant lamination adhesive composition. The non-halogenated lamination adhesive compositions as described herein can serve multiple purposes. For example, such non-halogenated lamination adhesive compositions can (1) provide the adhesive strength to hold the lamination together while maintaining flexibility and allowing for manipulation of the lamination without delamination or other failure modes, and (2) can also provide flame retardancy (FR) in the event of fire exposure. The insulation products described herein may include a base insulation layer composed of or including a composite or construction board, blanket, batt, pipes, or roll. Fiberglass based construction or composite boards are often used to insulate residential, industrial, or commercial structures or components (e.g., HVAC equipment, ductwork, piping).

FR performance is critical for such systems as the layers (e.g., paper) of a facer can act as a fuel source in the event of fire exposure, this is especially of concern when the layer acting as a fuel source is on the outside of the product. Thus, the laminating adhesive compositions described herein limit or prevent flame spread. The products described herein can be tested against ASTM E84 to determine FR performance.

The terms “kraft” or “kraft paper” as used herein refer to paper produced from chemical pulp produced in a kraft process that are, for example, used in commonly available FSK and ASJ facers.

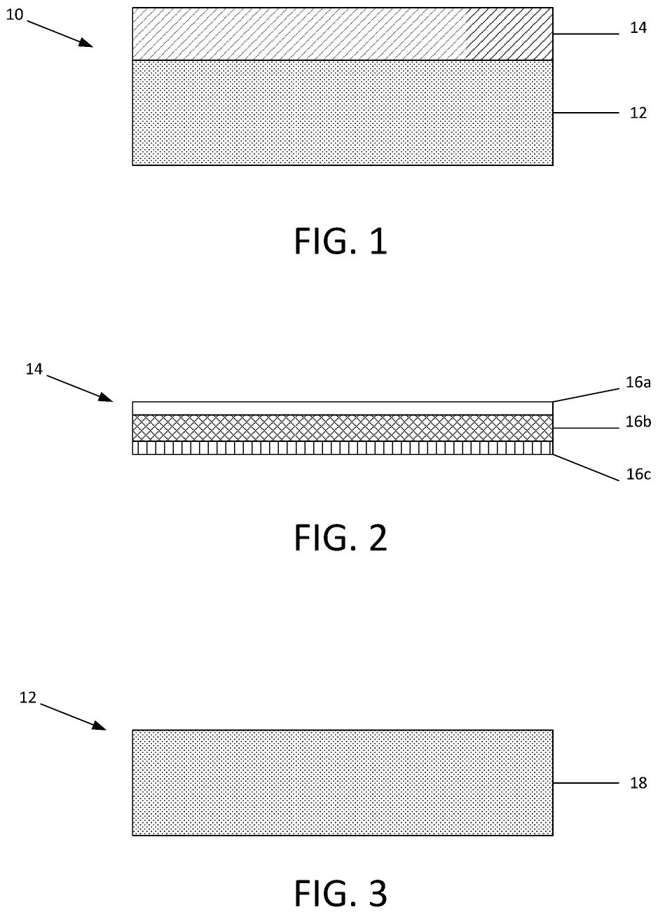

With reference to FIGS. 1-3, an insulation product 10 as described herein includes a base insulation layer 12 (e.g., an insulation product such as a construction or composite board or other suitable insulation layer) and at least one halogen-free facer 14 bonded with a halogen-free adhesive composition to one or more sides or surfaces of the base insulation layer 12. In some embodiments, the base insulation layer 12 may include a halogen-free facer as described herein on opposing sides or surfaces, as shown in FIG. 1.

As illustrated in FIG. 2, the halogen-free facer 14 comprises two or more layers 16 bonded together with a halogen-free adhesive composition. The halogen-free facer 14 may comprise, for example, a first face material or film layer 16a, a reinforcing layer 16b, and a second face material or film layer 16c, bonded or laminated together with an adhesive composition, although other compositions (e.g., with additional, different, intermediary or one or more omitted layers) are also possible. The first film layer 16a and the second film layer 16c may be bonded to opposing sides or surfaces of the reinforcing layer 16b to sandwich the reinforcing layer 16b therebetween. In some embodiments, the halogen-free facer 14 does not include kraft paper between the first film layer 16a and the reinforcing layer 16b or kraft paper does not form a portion of the first film layer 16a or the reinforcing layer 16b. In other embodiments, the halogen-free facer 14 does not include a kraft paper layer. In other embodiments, the halogen-free facer does not contain a reinforcing layer (e.g., scrim) 16b.

The first film layer 16a may be a paper (e.g., bleached or unbleached kraft), a foil (e.g., an aluminum), a polymeric layer (e.g., polypropylene film, coated polyester, or other suitable material), for example. In some embodiments, the first film layer 16a may be a kraft paper. In another embodiment, the first film layer 16a may be a white or substantially white film layer, for example, made of polypropylene or bleached kraft paper. In another embodiment, the first film layer 16a may be a brown or substantially brown film layer. In other embodiments, the first film layer 16a may be any color.

As the first film layer 16a may be a top surface or layer exposed in use (e.g., in a residential or commercial building), providing a white film layer or other suitably colored film may improve aesthetics as the halogen-free facer 14 may be less noticeable or blend in with an interior of a residential or commercial building. The first film layer 16a may also have a coating or be made of a suitable material such that it can be easily wiped of dust or other dirt particles. In other embodiments, the first film layer 16a may have an additional or different property, such as a desired smoothness, texture, and the like. The first film layer 16a may be adhered to a first side or surface (e.g., top side) of reinforcing layer 16b. For example, the first film layer 16a may be adhered with a non-halogenated flame resistant or retardant adhesive composition to the reinforcing layer 16b. The reinforcing layer 16b may be a fiberglass mat (e.g., a multi-directional reinforcing fiberglass scrim, yarn, or cloth). The second film layer 16c may be a polymeric film (e.g., a polyester), a paper (e.g., bleached or unbleached kraft), or a foil (e.g., an aluminum) layer adhered to a second side or surface (e.g., bottom side) of the reinforcing layer 16b with an adhesive.

In some embodiments, the first film layer and the second film layer may include a polymeric film. The first film layer may include a polypropylene film or polyester film. The polypropylene film may include a substantially white-colored film. In some embodiments, the second film layer includes a metallized polyester film or foil.

In some embodiments, the first film layer of the halogen-free facer is bonded directly to the reinforcing layer with an adhesive without any intermediary layers. In some embodiments, the bottom surface of the second film layer is laminated directly to a top surface of the insulation layer with an adhesive without any intermediary layers. In other embodiments, one or more intermediary layers can be located between the first film layer of the halogen-free facer and the reinforcing layer and/or between the second film layer and the insulation layer, for example.

According to exemplary embodiments, common values for a thickness of the first film layer 16a (e.g., polypropylene film layer) of the halogen-free facer 14 include between 0.0005 and 0.0025 inches, or between 0.0010 and 0.0020 inches, or 0.0015 inches.

As described above, reinforcing layer 16b may be a multi-directional reinforcing fiberglass scrim. The fiberglass scrim may have fiberglass strands of 4 per inch in machine and cross machine directions (e.g., MD and XMD), or 5 per inch in MD and XMD, or 1 and 3 per inch respectively in MD and XMD, for example. Common values for a thickness of the second film layer 16c (e.g., metallized polyester film layer) include between about 0.0001 and 0.0007 inches, between about 0.0002 and 0.0006 inches, between about 0.0002 and 0.0005 inches, between about 0.0002 and 0.0005 inches.

According to exemplary embodiments, common values of a weight of the halogen-free facer 14 include less than 35 lbs/1000 ft², e.g., between 5 and 35 lbs/1000 ft², between 8 and 35 lbs/1000 ft², between 10 and 30 lbs/1000 ft², between 15 and 25 lbs/1000 ft², or 20 and 25 lbs/1000 ft². According to ASTM C1136, minimum values of tensile strength of the non-moisture absorbing facer 14 include a 45 and 30 lbs/inch width in MD and XMD, respectively; or a 30 and 20 lbs/inch width in MD and XMD, respectively. Minimum values of bursting strength of the halogen-free facer 14 according to ASTM D774 include between 55 and 35 psi, for example, depending on type as determined by ASTM C1136. Maximum values of permeance according to ASTM E96 of the halogen-free facer 14 are to be below 0.02 perm. Common values for a thickness of the halogen-free facer 14 include, for example, from 0.002 to 0.01 inches (e.g., from 0.002 to 0.008 inches or from 0.004 to 0.006 inches).

As illustrated in FIG. 3, the base insulation layer 12 may include an insulation product in the form of a board, blanket, batt, pipe, or roll. The base insulation layer 12 may be constructed from fiberglass, foam, polyiso, or other suitable insulation material. In some embodiments, the base insulation layer 12 includes or is composed of an insulation board or construction board 18. The construction board 18 can be, in some instances, a rectangular board having a length L, a width W, and a thickness T, which may be selected based on the application in which the insulation product 18 will be used. Common values for the length L include 2-150 feet, whereas common values for the width W include 2-6 feet, and common values for the thickness T include 0.5-8 inches. The insulation product 18 may likewise have a material density or weight of between 0.5 and 6 lb/ft³. In some embodiments, the construction board 18 is a fiberglass based board made of an inorganic material (e.g., glass fibers) adhered together with a binder, such as a thermosetting binder or resin. In other embodiments, the construction board 18 may include polymeric fibers. The fiberglass based construction or composite board 18 may be a flexible, semi-rigid, or rigid board that varies in density. One or more opposing sides or surfaces of the construction or composite board 18 may be bonded to or laminated with the halogen-free facer 14 described herein. For example, a bottom surface or side of second film 16c of halogen-free facer 14 may be bonded to a top surface or side of the construction board 18. In some embodiments, the halogen-free facer 14 may match or mirror a size (e.g., length and width) or shape (e.g., rectangular) of the construction board 18. In other embodiments, the halogen-free facer 14 may have a different size or shape.

The insulation product 10 including the construction board 18 may be used for a variety of insulative applications including insulating residential, industrial, or commercial buildings, structures, or components; insulating oil or gas refineries components and/or structures; insulating chemical plant components and/or structures; and the like. Further, in other embodiments, the construction board 18 may not have a rectangular shape, but instead may be configured to be rolled or positioned about a circular object, such as a pipe. In other embodiments, the construction board 18 may not be a board, but rather may be a product that is shaped and configured to insulation various other shapes or even irregular shaped objects. For example, the insulation product 10 may be used as pipe insulation or may be a molded irregular sharp insulation product. Thus, the embodiments described and contemplated here are not limited to any particular geometric shape or design.

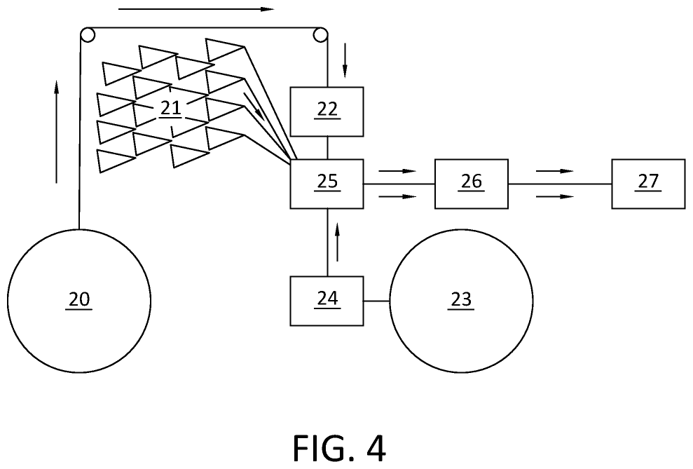

In some embodiments, the facings (e.g., FSK and ASJ facings) described herein are produced by coating the inner surface of a first face material 20 (e.g., paper) with the described laminating adhesives 22 as illustrated in FIG. 4. In the case of an FSK product, the paper can be un-bleached kraft paper. In the case of an ASJ product, the paper can be bleached kraft paper. In other aspects, the first face material 20 can be another material, such as foil, polymer film, for example. As discussed, the adhesive composition 22 is a non-halogenated flame retardant adhesive composition. In some aspects, the adhesive composition 22 comprises a phosphorous-containing component. In some aspects, the phosphorous-containing component can be a phosphorous-containing latex or a phosphorous-containing flame retardant.

Next, in some embodiments, the inner surface of a second face material 23 (e.g., aluminum foil) is coated with the described laminating adhesive composition 24. In other aspects, the second face material 20 can be another material, such as paper, polymer film, for example. In some aspects, the laminating adhesive composition 24 used to coat the second face material is the same as used to coat the first face material 20. In some aspects, the laminating adhesive composition 24 used to coat the second face material 23 is different than the laminating adhesive composition used to coat the first face material 20.

The thickness of the first and second face material or layers can be determined by the product needs. In some cases, the first and second face materials can be of the same thickness. In other cases, the first and second face materials have different thicknesses.

Next, in some embodiments, the inner surface of the first face material 20 is adhered to the inner surface of the second face material 23 with an optional reinforcing layer 21 between the first and second face materials. In some embodiments, the reinforcing layer 21 can be a fiberglass scrim, for example. After combining the materials 25, in some embodiments, the structure can be cured 26. Finally, in some embodiments, the combined and optionally cured structure can be wound into a finished roll 27.

As used below, any reference to a series of examples is to be understood as a reference to each of those examples disjunctively (e.g., “Examples 1-4” is to be understood as “Examples 1, 2, 3, or 4”).

Example 1 is a lamination adhesive composition, comprising: a non-halogenated flame retardant; and a non-halogenated latex; wherein the lamination adhesive composition is configured for use in a foil-scrim-kraft (“FSK”) or all-service-jacket (“ASJ”) product; and wherein the lamination adhesive composition is halogen-free.

Example 2 is composition of any of the examples, wherein the non-halogenated latex comprises at least one phosphate-containing compound.

Example 3 is the composition of any of the examples, wherein the non-halogenated flame retardant comprises at least one phosphate-containing compound.

Example 4 is the composition of any of the examples, wherein the at least one phosphate-containing compound of the non-halogenated latex and the at least one phosphate-containing compound of the non-halogenated flame retardant are different.

Example 5 is a vapor retarder material, comprising a first face material; a second face material; a non-halogenated flame retardant; and an non-halogenated latex;

wherein the non-halogenated flame retardant and the non-halogenated latex are both located between the first face material and the second face material.

Example 6 is the material of any of the examples, wherein the vapor retarder material is halogen-free.

Example 7 is the material of any of the examples, wherein the non-halogenated latex comprises at least one phosphate-containing compound.

Example 8 is the material of any of the examples, wherein the non-halogenated flame retardant comprises at least one phosphate-containing compound.

Example 9 is the material of any of the examples, wherein the first face material and the second face material are each chosen from paper, aluminum foil, polymeric film, or combinations thereof.

Example 10 is the material of any of the examples, wherein the first face material is aluminum foil and the second face material is paper.

Example 11 is the material of any of the examples, further comprising a reinforcing scrim located between the first face material and the second face material.

Example 12 is the material of any of the examples, wherein the reinforcing scrim comprises fiberglass strands.

Example 13 is the material of any of the examples, wherein the reinforcing scrim comprises fiberglass strands.

Example 14 is a process for making a foil-scrim-kraft (“FSK”) or an all-service-jacket (“ASJ”) product, comprising: coating an inner surface of a first face material with a non-halogenated flame retardant adhesive composition; coating an inner surface of a second face material with said non-halogenated flame retardant adhesive composition; positioning a reinforcing scrim between the coated inner surface of the first face material and the coated inner surface of the second face material; combining the coated inner surface of the first face material with the coated inner surface of the second face material with the reinforcing scrim in between to form a combined layer structure; curing the non-halogenated flame retardant adhesive composition; winding the combined layer structure to form a finished roll of FSK or ASJ product.

Example 15 is the process of any of the examples, wherein the first face material comprises paper.

Example 16 is the process of any of the examples, wherein the paper of the first face material is un-bleached kraft and the product is FSK.

Example 17 is the process of any of the examples, wherein the paper of the first face material is bleached kraft and the product is ASJ.

Example 18 is the process of any of the examples, wherein the second face material comprises aluminum foil.

Example 19 is the process of any of the examples, wherein the non-halogenated flame retardant adhesive composition comprises a non-halogenated flame retardant and a non-halogenated latex.

Example 20 is the process of any of the examples, wherein the non-halogenated flame retardant comprises at least one phosphate-containing compound and the non-halogenated latex comprises at least one phosphate-containing compound.

While several embodiments and arrangements of various components are described herein, it should be understood that the various components and/or combination of components described in the various embodiments may be modified, rearranged, changed, adjusted, and the like. For example, the arrangement of components in any of the described embodiments may be adjusted or rearranged and/or the various described components may be employed in any of the embodiments in which they are not currently described or employed. As such, it should be realized that the various embodiments are not limited to the specific arrangement and/or component structures described herein.

In addition, it is to be understood that any workable combination of the features and elements disclosed herein is also considered to be disclosed. Additionally, any time a feature is not discussed with regard in an embodiment in this disclosure, a person of skill in the art is hereby put on notice that some embodiments of the invention may implicitly and specifically exclude such features, thereby providing support for negative claim limitations.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a process” includes a plurality of such processes and reference to “the device” includes reference to one or more devices and equivalents thereof known to those skilled in the art, and so forth. The term “or” in reference to a list of two or more items, covers all of the following interpretations of the word: any of the items in the list, all of the items in the list, and any combination of items in the list.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

What is claimed is:

1. A lamination adhesive composition, comprising:
a non-halogenated flame retardant; and
a non-halogenated latex;
wherein the lamination adhesive composition is configured for use in a foil-scrim-kraft (“FSK”) or all-service-jacket (“ASJ”) product; and
wherein the lamination adhesive composition is halogen-free.

2. The lamination adhesive composition of claim 1, wherein the non-halogenated latex comprises at least one phosphate-containing compound.

3. The lamination adhesive composition of claim 1, wherein the non-halogenated flame retardant comprises at least one phosphate-containing compound.

4. The lamination adhesive composition of claim 1, wherein the non-halogenated latex comprises at least one phosphate-containing compound and the non-halogenated flame retardant comprises at least one phosphate-containing compound

5. A vapor retarder material, comprising:
a first face material;
a second face material;
a non-halogenated flame retardant;
and an non-halogenated latex;
wherein the non-halogenated flame retardant and the non-halogenated latex are both located between the first face material and the second face material.

6. The vapor retarder material of claim 5, wherein the vapor retarder material is halogen-free.

7. The vapor retarder material of claim 5, wherein the non-halogenated latex comprises at least one phosphate-containing compound.

8. The vapor retarder material of claim 5, wherein the non-halogenated flame retardant comprises at least one phosphate-containing compound.

9. The vapor retarder material of claim 5, wherein the first face material and the second face material are each chosen from paper, aluminum foil, polymeric film, or combinations thereof.

10. The vapor retarder material of claim 5, wherein the first face material is aluminum foil and the second face material is paper.

11. The vapor retarder material of claim 5, further comprising a reinforcing scrim located between the first face material and the second face material.

12. The vapor retarder material of claim 11, wherein the reinforcing scrim comprises fiberglass strands.

13. The vapor retarder material of claim 12, wherein the fiberglass strands are multi-directional.

14. A process for making a foil-scrim-kraft (“FSK”) or an all-service-jacket (“ASJ”) product, comprising:
coating an inner surface of a first face material with a non-halogenated flame retardant adhesive composition;
coating an inner surface of a second face material with said non-halogenated flame retardant adhesive composition;
positioning a reinforcing scrim between the coated inner surface of the first face material and the coated inner surface of the second face material;
combining the coated inner surface of the first face material with the coated inner surface of the second face material with the reinforcing scrim in between to form a combined layer structure;
curing the non-halogenated flame retardant adhesive composition;
winding the combined layer structure to form a finished roll of FSK or ASJ product.

15. The process of claim 14, wherein the first face material comprises paper.

16. The process of claim 15, wherein the paper of the first face material is un-bleached kraft and the product is FSK.

17. The process of claim 15, wherein the paper of the first face material is bleached kraft and the product is ASJ.

18. The process of claim 14, wherein the second face material comprises aluminum foil.

19. The process of claim 14, wherein the non-halogenated flame retardant adhesive composition comprises a non-halogenated flame retardant and a non-halogenated latex.

20. The process of claim 19, wherein the non-halogenated flame retardant comprises at least one phosphate-containing compound and the non-halogenated latex comprises at least one phosphate-containing compound.
